(19) United States
(12) Patent Application Publication
(10) Pub. No.: US 2023/0189008 A1
(43) Pub. Date: Jun. 15, 2023

(54) SHARED SPECTRUM COORDINATION

(71) Applicant: DISH Network L.L.C., Englewood, CO (US)

(72) Inventor: Henry Gregg Martch, Parker, CO (US)

(21) Appl. No.: 17/547,450

(22) Filed: Dec. 10, 2021

(51) Int. Cl. H04W 16/14; H04B 17/345; H04B 7/185

(52) U.S. Cl. CPC H04W 16/14; H04B 7/185; H04B 17/345

(57) ABSTRACT

Various arrangements for coordinating shared spectrum usage between fixed communication systems and flexible communication systems are provided. A network interference management system can detect signal interference events at satellite receivers configured to receive data from satellites utilizing predefined frequency bands. The network interference management system can determine a plurality of characteristics for the satellite receivers including a geographic location where the satellite receiver is located and an alignment for the satellite receiver. Based on the plurality of characteristics, an interference source can be identified and an indication of the signal interference event can be transmitted to the interference source by the network interference management system to cause the interference source to modify one or more operations.

### BACKGROUND

As radio spectrum becomes more heavily used, it can be possible to reuse particular frequencies. A first entity may have the senior rights to a frequency band (or particular frequency). A second entity may be permitted to operate within the same frequency band as long as little or no interference with the first entity results. Such an arrangement may be possible if interference caused by the second entity is detected and the second entity takes corrective action to avoid further interference.

### SUMMARY

Various embodiments are described related to a method for coordinating shared spectrum usage between fixed communication systems and flexible communication systems. The method may comprise detecting, by a network interference management system, a signal interference event at a satellite receiver. The satellite receiver may be configured to receive data from a satellite utilizing a predefined frequency band. The method may further comprise determining, by the network interference management system, a plurality of characteristics of the satellite receiver. The plurality of characteristics may comprise a geographic location where the satellite receiver is located and an alignment for the satellite receiver wherein the alignment is indicative of a field of view of the satellite receiver, and the satellite is within the field of view. The method may further comprise identifying, by the network interference management system and based at least in part on the plurality of characteristics, an interference source, wherein the interference source emits electromagnetic radiation within the predefined frequency band. The method may further comprise transmitting, by the network interference management system, an indication of the signal interference event to the interference source wherein the transmitted indication of the signal interference event causes the interference source to modify an operation of the interference source.

Embodiments of such a method may include on or more of the following features: wherein identifying the interference source comprises identifying, from a plurality of cellular network base stations configured to transmit cellular network data, an interfering base station located within the field of view of the satellite receiver. The method may further comprise receiving network activity data for the interfering base station, wherein the network activity data is indicative of times and frequencies at which the interfering base station transmitted the cellular network data to devices connected to a cellular network. The method may further comprise determining that the network activity data coincides with the signal interference event. The method may further comprise detecting a plurality of signal interference events comprising the signal interference event at a plurality of satellite receivers comprising the satellite receiver. The method may further comprise determining, for each of the plurality of satellite receivers, the plurality of characteristics. Identifying the interference source may further comprise identifying, from a plurality of cellular network base stations, an interfering base station located within the field of view of the satellite receiver and the fields of view of at least two other satellite receivers of the plurality of satellite receivers.

In some embodiments, the satellite receiver comprises a plurality of antenna feeds and identifying the interference source further comprises determining an amount of signal interference detected by each antenna feed of the plurality of antenna feeds. The method may further comprise receiving, at an active detector coupled with the satellite receiver, the electromagnetic radiation emitted by the interference source. The method may further comprise generating, by the active detector and based on the electromagnetic radiation received at the active detector, the signal interference event, wherein the signal interference event comprises at least one of an identification of the interference source, a frequency at which the electromagnetic radiation was received; or an angle of arrival of the electromagnetic radiation at the active detector. The method may further comprise transmitting the signal interference event to a satellite communication system coupled with the satellite.

In some embodiments the signal interference event is transmitted to the satellite communication system from the satellite receiver via the satellite. In some embodiments, the signal interference event is transmitted to the satellite communication system from the active detector via the interference source. In some embodiments, determining the alignment for the satellite receiver comprises determining an orbital location of the satellite. Determining the alignment for the satellite receiver may further comprise determining, based on the geographic location where the satellite receiver is located and the orbital location of the satellite, an elevation and an azimuth that positions the satellite within the field of view of the satellite receiver.

The method may further comprise determining, based on the signal interference event, a sub-band of the predefined frequency band at which the electromagnetic radiation emitted by the interference source causes interference at the satellite receiver. The method may further comprise disabling emissions by the interference source at the sub-band of the predefined frequency band. The method may further comprise determining, based on the geographic location for the satellite receiver and a location of the interference source, an emission angle from the interference source at which the electromagnetic radiation emitted by the interference source causes interference at the satellite receiver. The method may further comprise spatially filtering emission of the electromagnetic radiation at the emission angle. In some embodiments, the satellite is controlled by a satellite communication system. In some embodiments, the satellite communication system comprises the network interference management system. In some embodiments, the satellite is controlled by a satellite communication system communicatively coupled with the network interference management system and the method further comprises transmitting, by the satellite communication system, the signal interference event and the plurality of characteristics of the satellite receiver to the network interference management system.

In some embodiments, a shared spectrum communication system is described. The system may comprise a satellite configured to transmit data utilizing a predefined frequency band. The system may further comprise a satellite receiver configured to receive the data from the satellite. The system may further comprise a cellular network system comprising a plurality of base stations, wherein each base station of the plurality of base stations is configured to emit electromagnetic radiation within the predefined frequency band. The system may further comprise a network interference management system. The network interference management system may be configured to detect a signal interference event at the satellite receiver. The network interference management system may be further configured to determine a plurality of characteristics for the satellite receiver. The plurality of characteristics may comprise a geographic location where the satellite receiver is located and an alignment for the satellite receiver, wherein the alignment is indicative of a field of view of the satellite receiver, and the satellite is within the field of view. The network interference management system may be further configured to identify, based at least in part on the plurality of characteristics, an interfering base station of the plurality of base stations. The network interference management system may be further configured to transmit an indication of the signal interference event to the cellular network system wherein the transmitted indication of the signal interference event causes the interfering base station to modify an operation of the interfering base station.

Embodiments of such a system may include one or more of the following features: wherein identifying the interfering base station comprises identifying a base station of the plurality of base stations located within the field of view of the satellite receiver. The system may further comprise a plurality of satellite receivers comprising the satellite receiver, wherein the network interference management system is further configured to detect a plurality of signal interference events at the plurality of satellite receivers, the plurality of signal interference events comprising the signal interference event. The network interference management system may be further configured to determine, for each of the plurality of satellite receivers, the plurality of characteristics. The network interference management system may be further configured to identify, from a plurality of cellular network base stations, an interfering base station located within the fields of view of at least two other satellite receivers of the plurality of satellite receivers. The system may further comprise a satellite communication system comprising the satellite, the satellite receiver, and the network interference management system.

In some embodiments, a network interference management system is described. The network interference management system may be configured to perform operations including detecting a signal interference event at a satellite receiver, wherein the satellite receiver is configured to receive data from a satellite utilizing a predefined frequency band. The network interference management system may be further configured to perform operations including determining a plurality of characteristics of the satellite receiver. The plurality of characteristics may comprise a geographic location where the satellite receiver is located and an alignment for the satellite receiver, wherein the alignment is indicative of a field of view of the satellite receiver, and the satellite is within the field of view. The network interference management system may be further configured to perform operations including identifying an interference source, wherein the interference source emits electromagnetic radiation within the predefined frequency band. The network interference management system may be further configured to perform operations including transmitting an indication of the signal interference event to the interference source wherein the transmitted indication of the signal interference event causes the interference source to modify an operation of the interference source.

Embodiments of such a network interference management system may include one or more of the following features: wherein identifying the interference source comprises identifying, from a plurality of cellular network base stations configured to transmit cellular network data, an interfering base station located within the field of view of the satellite receiver. In some embodiments, the satellite is controlled by a satellite communication system and the satellite communication system comprises the network interference management system.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a block diagram of a spectrum sharing system for multiple communication systems according to some embodiments.

FIG. 2 illustrates a geographical region within which multiple communication systems operate according to some embodiments.

FIG. 3 illustrates an embodiment of a shared spectrum communication system that can include a satellite communication system and a cellular network communication system.

FIG. 4 illustrates an embodiment of a satellite communication system that can be integrated with a cellular network communication system.

FIG. 5 illustrates an embodiment of a method for coordinating shared spectrum usage between fixed communication systems and flexible communication systems.

### DETAILED DESCRIPTION OF THE INVENTION

A situation where multiple entities may have the rights to the same frequency band can involve a senior satellite-based user and a junior cellular network user. The senior satellite user may be an entity that operates on a particular frequency band and has senior rights to the frequency band. The junior cellular network user may be permitted to use the same frequency band as long as little or no interference occurs with the senior satellite-based user’s use of the frequency band.

Such an arrangement poses several unique challenges. First, cellular networks involve the use of many base stations transmitting at various frequencies within the particular frequency band. Even when interference is detected, there may be many possible base stations from which to choose as the source of the interference. Second, the satellite-based user and the cellular network user may be controlled and operated by separate entities. Once interference is detected by the satellite-based user, reducing or eliminating the interference by the cellular network user may include coordination between the separate entities.

Embodiments detailed herein can deal with these challenges and others. A feedback arrangement between a satellite operator and the cellular network may be established. Using the location of satellite receivers experiencing interference, an interfering base station of the many possible base stations may be identified based on the relative locations of the base station and the satellite receivers. After identifying the interfering base station, corrective action may be taken at the interfering base station to avoid further interference by the base station.

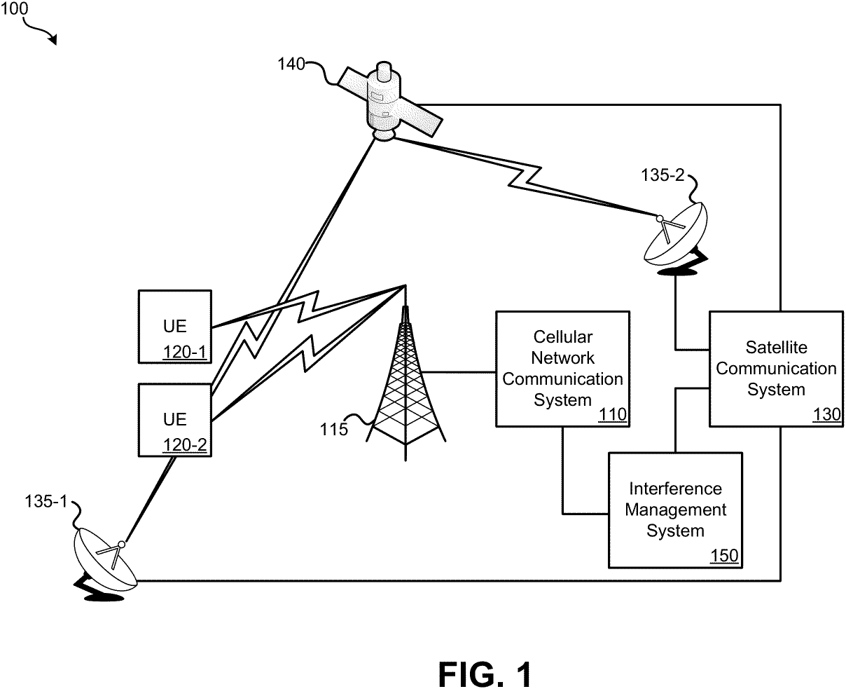

Further detail regarding these and other embodiments is provided in relation to the figures. FIG. 1 illustrates a block diagram of spectrum sharing system 100 for multiple communication systems according to some embodiments. Spectrum sharing system 100 can include cellular network communication system 110, satellite communication system 130, and interference management system 150. Each subsystem of spectrum sharing system 100 may be controlled by a single entity. For example, a single entity may control the operations of cellular network communication system 110 and satellite communication system 130. In this example, the entity may use a system, such as interference management system 150 to coordinate the activities of cellular network communication system 110 and satellite communication system 130. In some embodiments, each subsystem of spectrum sharing system 100 is controlled by a separate entity. For example, a first entity may control cellular network communication system 110, a second entity may control satellite communication system 130, and a third entity may utilize interference management system 150 to coordinate between the first and second entities.

Cellular network communication system 110 may be a telecommunication system configured to provide wireless voice and/or data transmission between multiple nodes. For example, cellular network communication system 110 may provide a voice communication connection between User Equipment (UE) 120-1 and UE 120-2. Cellular network communication system 110 may also provide a wireless connection between a plurality of nodes and the public switched telephone network and/or the Internet. For example, cellular network communication system 110 may provide a connection between UE 120 and the Internet.

Cellular Network communication system 110 may utilize one or more base stations 115 to transmit data between UE 120 and cellular network communication system 110. One or more base stations 115 may be distributed across a geographic area to create a cellular network for voice and/or data communications. Each base station 115 may provide services from cellular network communication system 110 to one or more UE 120 located within a region of the geographic area. The geographic area may be divided into multiple cells, or coverage areas, serviced by one or more base stations, such as base station 115. Base station 115 may be a structure with a fixed terrestrial location. Alternatively, base station 115 may be a satellite. For example, base station 115 may be a satellite in Low Earth Orbit (LEO) or Mid Earth Orbit (MEO). In some embodiments, base station 115 is one of a plurality of base stations comprising other satellites and/or other terrestrial structures.

Base station 115 may include one or more antennas and/or electronic communications equipment. The one or more antennas may configure base station 115 to emit electromagnetic radiation within a predefined frequency band. The predefined frequency band may include one or more electromagnetic frequency bands suitable for wireless communication, such as 12.2-12.7 GHz. The electromagnetic radiation may be used to wirelessly transmit data to UE 120 within a geographic proximity to base station 115. In some embodiments, base station 115 selects from a plurality of frequency sub-bands within the predefined frequency band on which to transmit and/or receive data. For example, base station 115 may select one or more sub-bands within the predefined frequency band to avoid using other sub-bands currently in use by adjacent base stations.

UE 120 can represent various types of end-user devices, such as smartphones, cellular modems, cellular-enabled computerized devices, sensor devices, gaming devices, access points (Aps), any computerized device capable of communicating via electromagnetic radiation at predefined frequency bands, etc. Depending on the location, UE 120 may receive data from base station 115 at one of a plurality of frequency sub-bands within a predefined frequency band. For example, UE 120 may receive data from base station 115 within a first frequency sub-band when UE 120 is located within a first sector extending from base station 115 and receive data from base station 115 within a second frequency sub-band when UE 120 is located within a second sector extending from base station 115.

Satellite communication system 130 may be a telecommunication system configured to distribute information via satellite transmissions. Satellite communication system 130 may distribute various types of data such as television, telephone, radio, data, and any information capable of wireless transmission. Satellite communication system 130 may distribute data using one or more satellites 140. Satellites 140 may relay uplinked data received from satellite communication system 130 to one or more satellite receivers 135. In some embodiments, satellite communication system 130, satellites 140, and satellite receivers 135 make up a direct broadcast satellite (DBS) system such as a satellite television system.

Satellites 140 may transmit data to satellite receivers 135 utilizing a predefined frequency band, such as 12.2-12.7 GHz. Each satellite receiver 135 may be configured to receive the data as a wireless transmission within the predefined frequency band from one or more satellites 140 via direct line of sight transmission. Each satellite receiver 135 may include a parabolic antenna configured to reflect electromagnetic radiation from a dish into one or more antenna feeds. In some embodiments, each satellite receiver 135 is configured to receive data from a single satellite 140. For example, a parabolic antenna of satellite receiver 135-1 may be aligned with satellite 140 while a parabolic antenna of satellite receiver 135-2 is aligned with a different satellite.

Each satellite receiver 135 may be associated with a plurality of characteristics including a geographic location where each respective satellite receiver 135 is located. Additionally, or alternatively, the plurality of characteristics may include an alignment for the satellite receiver and/or a parabolic antenna of the satellite receiver. The alignment may include an elevation angle and an azimuth angle. The elevation angle may be the angle of separation between a beam pointing direction of a parabolic antenna and a horizontal plane. The azimuth angle may be a rotational angle around a vertical axis with respect to a fixed heading. For example, a satellite receiver with an alignment including an elevation angle of 45 degrees and an azimuth angle of 180 degrees may indicate that a parabolic antenna of the satellite receiver is pointing due south at an angle of 45 degrees above the horizon.

In some embodiments, the alignment for a satellite receiver is indicative of a field of view of the satellite receiver. For example, based on the alignment and the radiation pattern of a particular parabolic antenna, a field of view within which electromagnetic radiation may be received by the parabolic antenna may be determined. Each satellite receiver 135 may be configured such that at least one satellite 140 is within the field of view. For example, satellite receiver 135-1 and satellite receiver 135-2 may each be aligned such that satellite 140 is in the field of view of each respective satellite receiver 135.

In some embodiments, the electromagnetic radiation emitted by a base station causes interference at one or more satellite receivers. For example, if base station 115 is within the field of view of satellite receiver 135-1 and emitting electromagnetic radiation within the same predefined frequency band as satellite 140, interference can result in satellite receiver 135-1 being unable to receive data transmissions from satellite 140. In the embodiments detailed herein, the operator of satellite communication system 130 and/or satellites 140 is the senior user of the predefined frequency band. Accordingly, cellular network communication system 110 is required to not interfere with the operations of satellites 140 and/or satellite communication system 130.

Interference management system 150 may be one or more computer servers or a process hosted on a cloud-based computing platform. Interference management system 150 may be in communication with cellular network communication system 110 and/or satellite communication system 130. In some embodiments, satellite communication system 130 includes interference management system 150. Alternatively, interference management system 150 may be controlled by an independent entity separate from cellular network communication system 110 and/or satellite communication system 130.

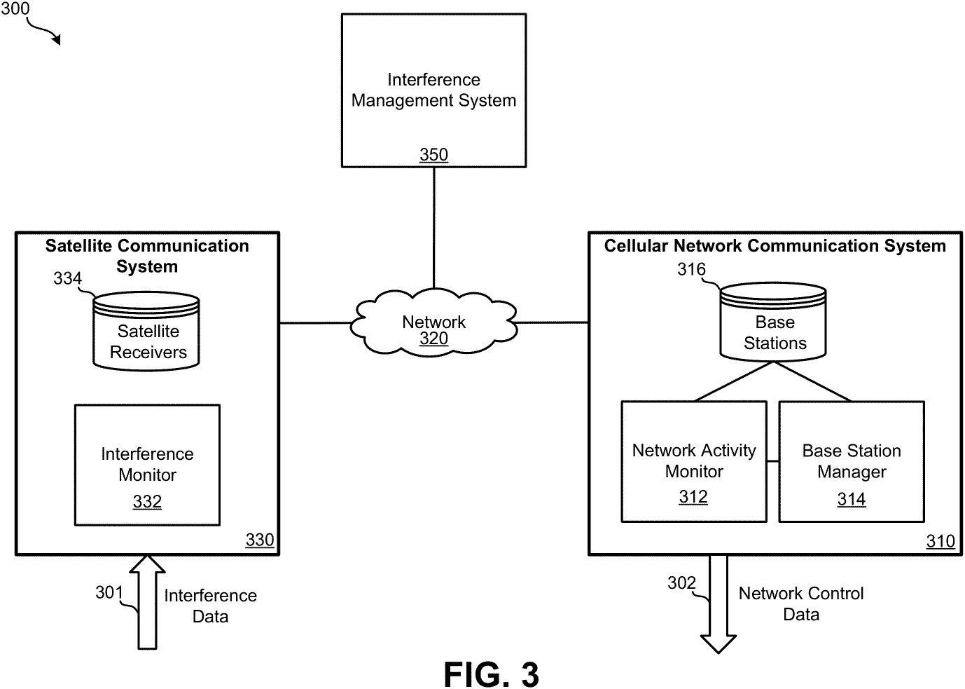

Interference management system 150 may be configured to coordinate the use of the predefined frequency band by cellular network communication system 110 and satellite communication system 130. For example, interference management system 150 may receive indications of interference by cellular network communication system 110 with communications between satellites 140 and satellite receivers 135 and cause cellular network communication system 110 to modify one or more operations to avoid further interference. Further detail regarding interference management system 150 is provided in relation to FIG. 3.

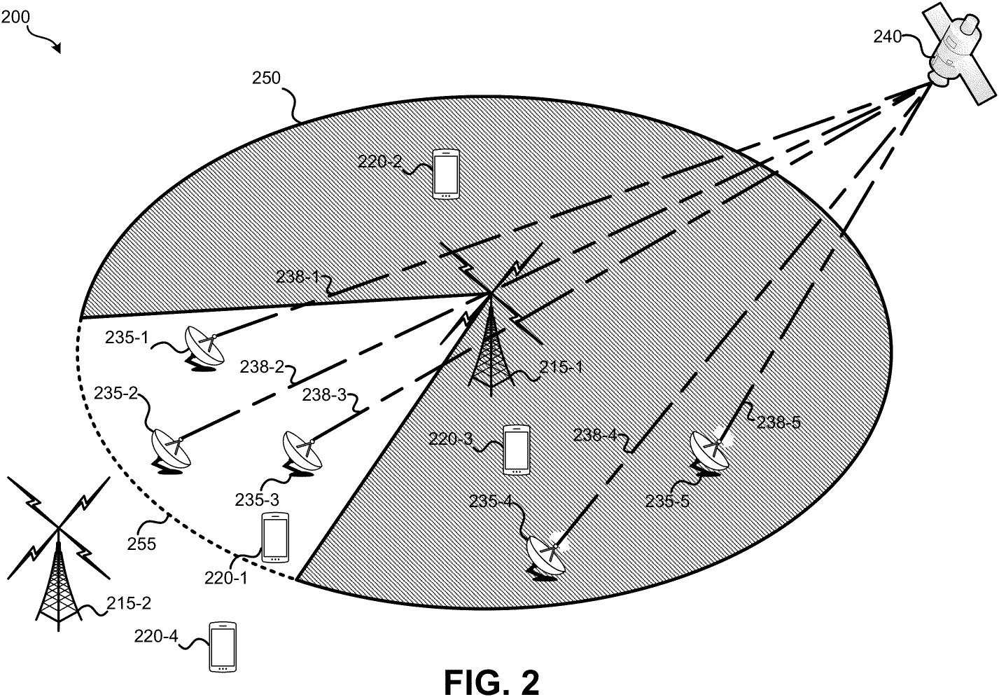

FIG. 2 illustrates a geographical region 200 within which multiple communication systems operate according to some embodiments. Geographical region 200 may correspond to one or more cells, or coverage areas, within which a cellular network communication system, such as cellular network communication system 110 as described above, provides cellular network services. Geographical region 200 may also be within a coverage area of a satellite communication system, such as satellite communication system 130 as described above. For example, a satellite communication system may operate one or more satellites, such as satellite 240, above geographical region 200 in order to provide one or more types of services, such as satellite television.

As illustrated, geographical region 200 includes a plurality of satellite receivers 235. The plurality of satellite receivers 235 may be the same or operate in a similar manner as satellite receivers 135 as described above. For example, each of the plurality of satellite receivers 235 may be configured to receive data from satellite 240. Satellite 240 may transmit data utilizing a predefined frequency band. In some embodiments, satellite 240 is in a fixed position relative to each of the plurality of satellite receivers 235. For example, satellite 240 may be in a geostationary, or geosynchronous, orbit above the earth’s equator at a predefined longitude. Depending on its position in geostationary orbit, one or more antennas coupled with satellite 240 may transmit data to satellite receivers within a particular coverage area of the earth’s surface. For example, if satellite 240 were positioned at a longitude in the western hemisphere, satellite 240 might provide coverage to parts of North, Central, or South America.

Each of the plurality of satellite receivers 235 may include a respective alignment that achieves a direct line of sight between the satellite receiver and satellite 240. Achieving a direct line of sight between the satellite receiver and satellite 240 may include aligning the satellite receiver in order to position satellite 240 within a field of view of the satellite receiver. As illustrated, satellite 240 is within the respective fields of view 238 of each of the plurality of satellite receivers 235.

The alignment for each of the plurality of satellite receivers 235 that positions the satellite within the field of view may be determined based on the geographic location of the respective satellite receiver as well as the orbital location of satellite 240. As described above, the alignment may include an elevation angle and an azimuth angle. The elevation angle of a satellite receiver may be determined based on the latitude of the satellite receiver. For example, satellite receivers located closer to the equator, such as satellite receiver 235-5, may have a greater elevation angle compared with satellite receivers located further away from the equator, such as satellite receiver 235-2. The azimuth angle of a satellite receiver may be determined based on the relative longitudes of the satellite and the satellite receiver. For example, satellite receivers east of satellite 240, such as satellite receiver 235-1, may have a greater azimuth angle compared with satellite receivers west of satellite 240, such as satellite receiver 235-4.

As illustrated, geographical region 200 includes a plurality of base stations 215 configured to transmit cellular network data to multiple UE 220 within geographical region 200. Each base station of the plurality of base stations 215 may be the same or operate in a similar manner as base station 115 as described above. For example, each of the plurality of base stations 215 may transmit cellular network data by emitting electromagnetic radiation from one or more antennas of the respective base station.

Each of the plurality of base stations 215 may transmit cellular network data to UE within a coverage area. For example, base station 215-1 may transmit cellular network data to UE 220-1, UE 220-2, and UE 220-3 located within coverage area 250 while base station 215-2 transmits cellular network data to UE 220-4 outside coverage area 250. Coverage area 250 may be a geographic area within which electromagnetic radiation emitted by base station 215-1 is strong enough to be received by UE 220. Depending on the number, type, and power available to the antennas of base station 215-1, coverage area 250 may be any size and shape, such as circular, elliptical, or triangular. In some embodiments, the coverage area of one base station may overlap with the coverage areas of one or more adjacent base stations. For example, coverage area 250 may overlap with a coverage area for base station 215-2. In this case, UE located within the overlapping coverage areas may be able to receive cellular network data from either base station 215-1 or base station 215-2.

Each of the plurality of base stations 215 may transmit cellular network data within a predefined frequency band and/or at a plurality of sub-bands within a predefined frequency band. For example, base station 215-1 may transmit using a first subset of the plurality of sub-bands while base station 215-2 may transmit using a second subset of the plurality of sub-bands. Adjacent base stations of the plurality of base stations 215 may use non-overlapping subsets of the plurality of sub-bands to avoid interfering with each other. Additionally or alternatively, each of the plurality of base stations 215 may utilize subsets of the plurality of sub-bands that do not overlap with other subsets used by other applications, such as satellite communications, as further described below.

In some embodiments, each of the plurality of base stations 215 are capable of dynamically altering the shape and size of their respective coverage areas. For example, each of the plurality of base stations 215 may spatially filter the electromagnetic radiation produced by one or more antennas of the base station. Using spatial filtering, base stations may greatly reduce or eliminate electromagnetic radiation emitted by the base station at specific angles and/or across specific sectors of the available coverage area. For example, base station 215-1 may use spatial filtering to avoid emitting electromagnetic radiation across sector 255 extending away from base station 215-1 while still emitting electromagnetic radiation across the remainder of coverage area 250.

One or more of the plurality of satellite receivers 235 within geographical region 200 may experience interference events due to other electromagnetic radiation within geographical region 200. An interference event may include any event that results in the reduced ability of a satellite receiver to receive data from a satellite. Interference events may occur as a result of electromagnetic radiation within the predefined frequency band used by a satellite to communicate with satellite receivers, from a source within the field of view of a satellite receiver other than the satellite. For example, as illustrated, because base station 215-1 is within field of view 238-1 of satellite receiver 235-1, electromagnetic radiation produced by base station 215-1 within the same predefined frequency band utilized by satellite 240 may cause an interference event at satellite receiver 235-1.

Interference events may include a transitory or prolonged inability to receive data from a satellite. For example, satellite receiver 235-3 may experience a transitory interference event as a result of a single transmission from base station 215-1 to UE 220-1. As another example, satellite receiver 235-3 may experience a prolonged interference event as a result of continuous transmission from base station 215-1 to UE 220-1.

In some embodiments, identifying an interference source, or cause of an interference event at a satellite receiver, is based on a plurality of characteristics of the satellite receiver. For example, based on the location and alignment of satellite receiver 235-2, it may be determined that base station 215-1 is the interference source, as opposed to base station 215-2, because base station 215-1 is within field of view 238-2, while base station 215-2 is not. In some embodiments, interference events detected at a plurality of satellite receivers are correlated to identify an interference source. For example, interference events detected at satellite receiver 235-1, satellite receiver 235-2, and satellite receiver 235-3 may be used to determine that base station 215-1 is the interference source because it is the only base station within field of view 238-1, field of view 238-2, and field of view 238-3.

In some embodiments, interference events detected at a satellite receiver may be used to reduce or eliminate future interference events at the satellite receiver. For example, after determining that base station 215-1 is an interference source, or has caused interference events at multiple satellite receivers within coverage area 250, one or more operations of base station 215-1 may be modified to avoid additional interference events caused by base station 215-1. The modified operations may include disabling subsequent electromagnetic emissions at one or more sub-bands within the predefined frequency band utilized by satellite 240. Subsequent emissions at the one or more sub-bands may be disabled based on a determination that emissions at those sub-bands were the cause of the interference at the satellite receiver. In this case, other sub-bands within the predefined frequency band may be used for subsequent transmissions.

Additionally or alternatively, the modified operations may include spatially filtering electromagnetic emissions. After identifying an interference source, it may be determined, based on the location of the satellite receiver and the interference source, an emission angle from the interference source at which the electromagnetic radiation emitted by the interference source causes interference at the satellite receiver. For example, the emission angle from base station 215-1 to satellite receiver 235-1 may be at approximately 270 degrees. As another example, the emission angle from base station 215-1 to satellite receiver 235-2 may be at approximately 220 degrees. Based on the determined emission angle, the interference source may spatially filter electromagnetic radiation at the emission angle. In some cases, the interference source may spatially filter electromagnetic radiation at a range of emission angles. For example, base station 215-1 may spatially filter emissions within sector 255 between 220 degrees and 270 degrees to avoid further interference at satellite receiver 235-1, satellite receiver 235-2, and satellite receiver 235-3.

FIG. 3 illustrates an embodiment of a shared spectrum coordination system 300 (“system 300”). System 300 can include cellular network communication system 310, satellite communication system 330, and interference management system 350. Network 320 may be used for communication between any of cellular network communication system 310, satellite communication system 330, and/or interference management system 350. Network 320 may include one or more public and/or private networks. Network 320 can include the Internet, over which data is routed.

Satellite communication system 330 may be the same, or function in a similar manner, as satellite communication system 130 as described above. For example, satellite communication system 330 may control one or more satellites configured to distribute information to a plurality of satellite receivers. Satellite communication system 330 includes interference monitor 332 and satellite receiver database 334. Satellite communication system 330 may also include other components configured to monitor and control the operations of one or more satellites. Satellite communication system 330 may include one or more special-purpose or general-purpose processors. Such special-purpose processors may include processors that are specifically designed to perform the functions of the components detailed herein. Such special-purpose processor may be ASICs or FPGAs, which are general-purpose components that are electronically and programmatically configured to perform the functions detailed herein. Such general-purpose processors may execute special-purpose software that is stored using one or more non-transitory processor-readable mediums, such as random access memory (RAM), flash memory, a hard disk drive (HDD), or a solid state drive (SSD). Further, the functions of the components of satellite communication system 330 can be hosted on a cloud-computing platform, which is managed by a separate cloud-service provider that provides computing and storage resources for clients.

Interference monitor 332 may serve to process interference data detected at satellite receivers. Interference data 301 received by interference monitor 332 may be analyzed to determine a source of the interference detected at one or more satellite receivers. Interference data 301 may include various types of information such as an identification of the satellite receiver at which interference was detected, the frequency or frequencies at which the interference was detected, and/or an angle of arrival of the interference at the detecting satellite receiver. Interference data 301 may be transmitted to satellite communication system 330 via the one or more satellites controlled by satellite communication system 330. Additionally or alternatively, interference data 301 may be received directly via a network connection from a satellite receiver.

After receiving interference data 301, interference monitor 332 may access records related to the satellite receiver at which the interference was detected. For example, interference monitor 332 may access satellite receiver database 334 to determine a plurality of characteristics of the satellite receiver. The plurality of characteristics may include: the geographic location where the satellite receiver is located, one or more satellites from which the satellite receiver is configured to receive data, and/or an alignment of the satellite receiver.

In some embodiments, interference monitor 332 correlates interference data 301 received from a plurality of satellite receivers. Based on the information included in interference data 301 and the records related to each satellite receiver at which interference was detected, interference monitor 332 may determine that the interference detected at each satellite receiver should be correlated. For example, interference data 301 received from a plurality of satellite receivers in close proximity may indicate that the interference detected at each satellite receiver is as a result of a single interference source.

In some embodiments, interference monitor 332 analyzes interference data 301 to determine whether the interference detected at a satellite receiver is as a result of interfering electromagnetic emissions or some other cause. For example, interference monitor 332 may determine that interference data 301 indicating periodic and/or gradual increases and decreases is as a result of a physical obstruction between the satellite receiver and the satellite. As another example, interference monitor 332 may determine, based on a lack of interference data 301 from other satellite receivers within close proximity to the satellite receiver detecting the interference, that the interference is not associated with interfering electromagnetic emissions.

After analyzing interference data 301 and the records related to the one or more satellite receivers at which interference was detected, interference monitor 332 may generate a signal interference event. A signal interference event may include information from interference data 301 as well as information from satellite receiver database 334. In some embodiments, interference monitor 330 may transmit the signal interference event to another service or component for additional processing and/or action. For example, interference monitor 332 may transmit the signal interference event, or an indication of the signal interference event to interference management system 350.

Cellular network communication system 310 may be the same, or function in a similar manner, as cellular network communication system 110 as described above. For example, cellular network communication system 310 may control one or more cellular base stations configured to provide cellular network services. Cellular network communication system 310 can include various components. Such components can include: network activity monitor 312, base station manager 314, and base station database 316. Cellular network communication system 310 may include one or more special-purpose or general-purpose processors. Such special-purpose processors may include processors that are specifically designed to perform the functions of the components detailed herein. Such special-purpose processors may be ASICs or FPGAs which are general-purpose components that are physically and electrically configured to perform the functions detailed herein. Such general-purpose processors may execute special-purpose software that is stored using one or more non-transitory processor-readable mediums, such as random access memory (RAM), flash memory, a hard disk drive (HDD), or a solid state drive (SSD). Further, the functions of the components of cellular network communication system 310 can be implemented using a cloud-computing platform, which is operated by a separate cloud-service provider that executes code and provides storage for clients.

Base station manager 314 may serve to control operations at each base station of a cellular network. Operations controlled by base station manager 314 may include the frequency sub-bands used by each base station and/or the directionality of the electromagnetic radiation produced by each base station. For example, base station manager 314 may cause a particular base station to disable subsequent emissions at one or more sub-bands within a predefined frequency band and transition to one or more other sub-bands within the predefined frequency band. As another example, base station manager 314 may cause a particular base station to use spatial filtering to avoid emitting electromagnetic radiation at one or more emission angles and/or across a sector of the possible coverage area provided by the particular base station. Base station manager 314 may control the operations of each base station by transmitting network control data 302 to each respective base station.

Base station manager 314 may read and write information related to the operating parameters of each base station to base station database 316. For example, base station manager 314 may access base station database 316 to identify available base stations within a geographic region. After identifying the available base stations, base station manager 314 may proceed to define the operating parameters for each base station within the geographic region. After defining the operating parameters, base station manager 314 may store the operating parameters for each base station in base station database 316 in a record associated with the respective base station. As subsequent changes to the operating parameters of a base station are made, base station manager 314 may proceed to update the record in base station database 316.

Network activity monitor 312 may serve to monitor and/or record the network activity at each base station. The network activity may include information related to transmissions from each base station. For example, the network activity may indicate at what times and at which frequencies a particular base station was transmitting to UE. As base stations transmit data to UE, network activity monitor 312 may store the network activity in base station database 316 in association with the respective base station that transmitted the data.

In some embodiments, network activity monitor 312 transmits network activity to satellite communication system 330 and/or interference management system 350. Network activity monitor 312 may transmit the network activity data in response to a request for specific network activity data. For example, after receiving a request for network activity within a specific region and/or within a specified timeframe, network activity monitor 312 may access the stored network activity data in base station database 316 related to the requested region and/or timeframe. After identifying the relevant information in base station database 316, network activity monitor 312 may proceed to transmit the network activity data to the requesting entity.

Interference management system 330 may include one or more special-purpose or general-purpose processors. Such special-purpose processors may include processors that are specifically designed to perform the functions of the components detailed herein. Such special-purpose processors may be ASICs or FPGAs which are general-purpose components that are physically and electrically configured to perform the functions detailed herein. Such general-purpose processors may execute special-purpose software that is stored using one or more non-transitory processor-readable mediums, such as random access memory (RAM), flash memory, a hard disk drive (HDD), or a solid state drive (SSD). Further, the functions of interference management system 350 can be implemented using a cloud-computing platform, which is operated by a separate cloud-service provider that executes code and provides storage for clients.

In some embodiments, interference management system is incorporated as a part of satellite communication system 330. For example, interference management system 350 may be a separate process controlled by satellite communication system 330. In some embodiments, interference management system 350 is controlled by an entity separate from either satellite communication system 330 and/or cellular network communication system 310.

Interference management system 350 may coordinate between the respective operations of satellite communication system 330 and cellular network communication system 310 in order to reduce interference caused by the activities of cellular network communication system 310. For example, interference management system 350 may detect signal interference events at satellite receivers of satellite communication system 330, identify a base station from cellular network communication system 310 that is the cause of the interference, and cause cellular network communication system 310 to modify one or more operations of the interfering base station.

In some embodiments, interference management system 350 detects signal interference events at satellite receivers. For example, interference management system 350 may receive interference data related to a satellite receiver from satellite communication system 330. Based on the interference data, interference management system 350 may detect a signal interference event at the satellite receiver. Additionally, or alternatively, interference management system 350 may receive the signal interference events generated by satellite communication system 330. Based on the interference data and/or the signal interference event received from satellite communication system 330, interference management system 350 may determine a plurality of characteristics of the satellite receiver associated with the interference data and/or signal interference event.

In some embodiments, interference management system 350 uses the plurality of characteristics of the satellite receiver to identify the source of the interference. For example, interference management system 350 may identify a base station within the field of view of a satellite as the potential source of the interference. Additionally, or alternatively, interference management system 350 may analyze network activity data received from cellular network communication system 310 to determine that the signal interference event coincides with network activity at the identified base station.

In some embodiments, after identifying an interference source as the cause of a signal interference event, interference management system 350 may transmit an indication of the signal interference event to the interference source. For example, interference management system 350 may transmit an indication of the signal interference event to cellular network communication system 310. Transmitting the indication of the signal interference event to the interference source may cause the interference source to modify an operation of the interference source. For example, after transmitting the indication of the signal interference event to cellular network communication system 310, base station manager 314 may transmit network control data 302 to the identified base station to modify the operating parameters of the base station to avoid subsequent signal interference events.

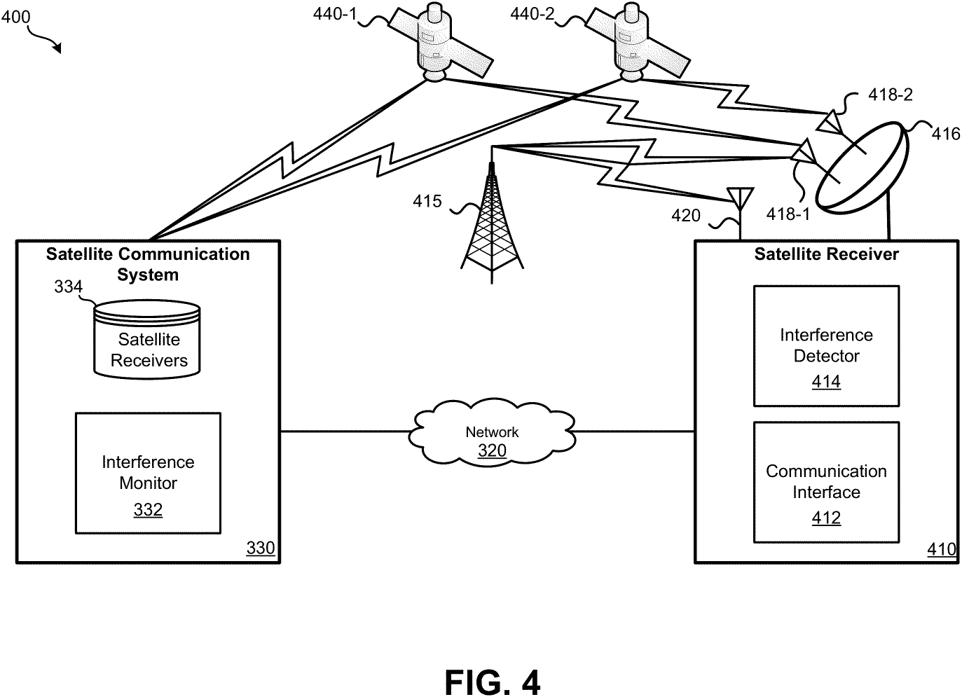

FIG. 4 illustrates an embodiment of a satellite system 400 that can be integrated with a cellular network communication system. Satellite system 400 can include satellite communication system 330, satellites 440, and satellite receiver 410. Satellite communication system 330 may be the same, and/or function in a similar manner, as described above. For example, satellite communication system 330 may transmit information to satellite receiver 410 via satellites 440. As another example, interference monitor 332 may receive interference data from satellite receiver 410.

Satellite receiver 410 may include communication interface 412 and interference detector 414. Satellite receiver 410 may include one or more special-purpose or general-purpose processors. Such special-purpose processors may include processors that are specifically designed to perform the functions of the components detailed herein. Such special-purpose processors may be ASICs or FPGAs which are general-purpose components that are electronically and programmatically configured to perform the functions detailed herein. Such general-purpose processors may execute special-purpose software that is stored using one or more non-transitory processor-readable mediums, such as random access memory (RAM), flash memory, a hard disk drive (HDD), or a solid state drive (SSD).

Satellite receiver 410 may also include, and/or be coupled with, parabolic antenna 416, antenna feeds 418, and active detector 420. Parabolic antenna 416 may be a directional antenna configured to receive data transmitted within a predefined frequency band from satellites 440. Data transmitted by satellites 440 towards parabolic antenna 416 may be reflected into one or more antenna feeds 418. Antenna feeds 418 may each be configured to receive data at particular frequencies, polarizations, and/or angles. For example, antenna feed 418-1 may be configured to receive data transmitted within a first sub-band of a predefined frequency band while antenna feed 418-2 may be configured to receive data transmitted within a second sub-band of the predefined frequency band.

Additionally, or alternatively, antenna feeds 418 may each be configured to receive data from a respective satellite of satellites 440. For example, antenna feed 418-1 may have a first alignment to receive data from satellite 440-1 located at a first orbital location. Similarly, antenna feed 418-2 may have a second alignment to receive data from satellite 440-2 located at a second orbital location. Each alignment may be configured such that a respective satellite of satellites 440 is within a field of view of a respective antenna feed of antenna feeds 418. The field of view of satellite receiver 410 may include the combined fields of view of each respective antenna feed.

Active detector 420 may include one or more directional antennas configured to detect electromagnetic radiation from sources other than satellites 440. Other sources of electromagnetic radiation detectable by active detector 420 may include cellular network base stations, such as interfering base station 415, controlled by a cellular network communication system, such as cellular network communication system 310 as described above. Active detector 420 may be configured to determine one or more characteristics associated with the electromagnetic radiation received at active detector 420 from an interference source. The one or more characteristics may include the frequencies at which the electromagnetic radiation was received and/or an angle of arrival of the electromagnetic radiation.

In some embodiments, active detector 420 generates signal interference data based on the received electromagnetic radiation from the interference source. The signal interference data generated by active detector 420 may include an identification of the interference source, a frequency at which the electromagnetic radiation was received, and/or the angle of arrival of the electromagnetic radiation. In some embodiments, active detector 420 transmits the generated signal interference data to satellite communication system 330 via the interference source.

Interference detector 414 may detect signal interference at satellite receiver 410. For example, interference detector 414 may monitor the received signal strength of the data transmission from satellites 440 at each of the one or more antenna feeds 418. Interference detector 414 may then determine an amount of signal interference at each feed based on the signal strength received by each feed. In some embodiments, when interference detector 414 detects that the signal strength of the data transmission is below a predefined signal strength threshold, interference detector 414 may determine that there is signal interference. As another example, interference detector 414 may receive data generated by active detector 420 related to electromagnetic radiation received by active detector 420 and determine that the electromagnetic radiation is interfering with the data transmission from satellites 440.

In some embodiments, interference detector 414 determines a localized angle of arrival of the interference based on the particular antenna feed experiencing the interference. For example, interference detector 414 may determine that antenna feed 418-2 is receiving less interfering electromagnetic radiation compared with the amount of interference received by antenna feed 418-1. Based on the relative alignments of antenna feed 418-1 to receive data from satellite 440-1 and antenna feed 418-2 to receive data from satellite 440-2, interference detector 414 may determine that the angle of arrival from the source of the interference is closer to the center of the field of view of antenna feed 418-1 compared to the center of the field of view of antenna feed 418-2.

After detecting and/or determining that satellite receiver 410 is experiencing signal interference, interference detector 414 may generate interference data. The interference data may include various types of information such as an identification of satellite receiver 410, the frequency or frequencies at which the interference was detected, and/or an indication of the angle of arrival of the interference at the detecting satellite receiver. After generating the interference data, interference detector 420 may proceed to transmit the interference data to interference monitor 332 of satellite communication system 330, as described above.

Communication interface 412 may be used to transmit the interference data to satellite communication system 330. Communication interface 412 may transmit interference data to satellite communication system 330 via satellites 440. Additionally, or alternatively, communication interface 412 may transmit interference data to satellite communication system 330 via a network, such as network 320 as described above.

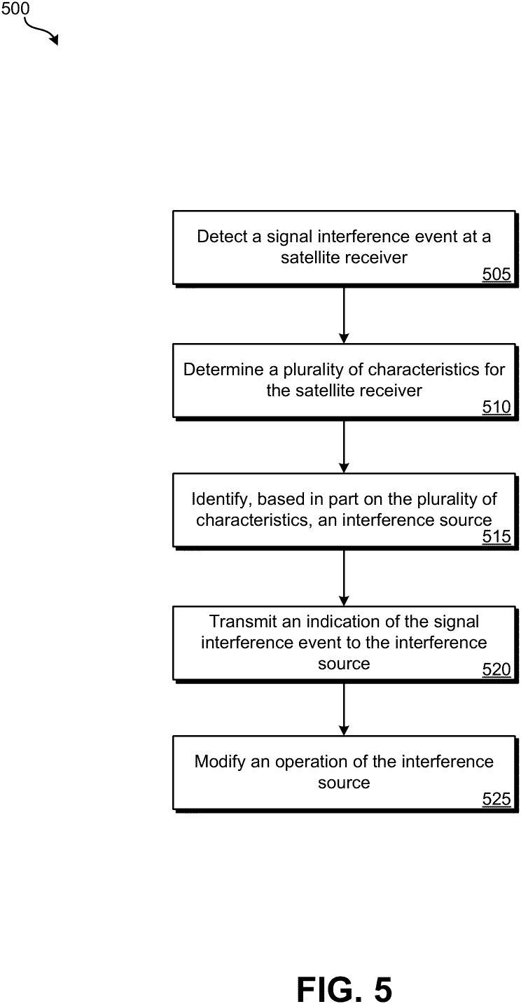

Various methods may be performed using the systems and arrangements detailed in relation to FIGS. 1-4. FIG. 5 illustrates an embodiment of a method 500 for coordinating shared spectrum usage between fixed communication systems and flexible communication systems. The blocks of method 500 can be performed by one or more combinations of the systems and components described in relation to FIGS. 1-4. For example, interference management system 350 as described above may perform one or more blocks of method 500. Additionally, or alternatively, satellite communication system 330 as described above may perform one or more blocks of method 500.

At block 505, a signal interference event may be detected at a satellite receiver. The satellite receiver may be configured to receive data from a satellite utilizing a predefined frequency band. The satellite may be controlled by a satellite communication system, such as satellite communication system 330 as described above. In some embodiments, the satellite receiver, the satellite, and the satellite communication system are part of a direct broadcast system configured to broadcast satellite television from one or more satellites to a plurality of satellite receivers. The signal interference event may be detected as a result of the satellite receiver no longer being able to receive data from the satellite. The signal interference event may be one of a plurality of signal interference events detected at a plurality of satellite receivers.

At block 510, a plurality of characteristics for the satellite receiver can be determined. The plurality of characteristics may include a geographic location where the satellite receiver is located and an alignment for the satellite receiver. The alignment for the satellite receiver may be determined by using the orbital location of the satellite and the geographic location where the satellite receiver is located to calculate the elevation and azimuth angles that position the satellite within the field of view of the satellite receiver. In some embodiments, determining the plurality of characteristics is performed by accessing a record in a database associated with the satellite receiver. An interference management system, such as interference management system 350 as described above, may determine the plurality of characteristics for the satellite receiver by requesting the plurality of characteristics from a satellite communication system, such as satellite communication system 330 as described above.

At block 515, an interference source can be identified based in part on the plurality of characteristics. The interference source may be a cellular network base station configured to transmit cellular network data by emitting electromagnetic radiation within the predefined frequency band utilized by the satellite. The cellular network base station may be identified from a plurality of base stations by identifying a base station within the field of view of the satellite receiver. Network activity data for the identified base station may be analyzed to confirm that the identified base station is the cause of the signal interference event. In some embodiments, other signal interference events detected at a plurality of other satellite receivers within the proximity of the satellite receiver are used in conjunction with the signal interference event to identify the interference source. For example, the interfering base station may be identified based on its location within the field of view of a plurality of satellite receivers.

Additionally, or alternatively, the interference source of the satellite receiver may be identified based on a lack of signal interference at one or more other satellite receivers. For example, after detecting an interference event at the first satellite receiver, it may be determined that a signal interference event has not been detected at a second satellite receiver within a predefined proximity to the first satellite receiver. Accordingly, it may be determined that a potential interference source within the fields of view of both satellite receivers is not the source of the interference at the first satellite receiver. This may be the case, for example, when there is a physical obstruction, such as foliage, or cloud cover, affecting one, or a limited number of satellite receivers. Alternatively, this may be the case when there are two potential interference sources within the field of view of the first satellite receiver, but only one of the two potential interference sources is within the field of view of the second satellite receiver. In this case, the potential interference source that is not within the field of view of the second satellite receiver may be identified as the interference source from the two potential interference sources within the field of view of the first satellite receiver.

In some embodiments, the interference source of the satellite receiver is identified based on a comparison of signal strength between two or more antenna feeds of the satellite receiver. For example, after detecting a signal interference event at a satellite receiver, it may be determined that the satellite receiver has two or more antenna feeds configured to receive data from multiple respective satellites at different orbital locations. Based on the location of the respective satellites, respective fields of view for each antenna feed may be determined. Based on the relative signal strength received by each antenna feed and the respective fields of view, it may be determined that an interference source that is more central in a field of view of one antenna feed compared to the fields of view for one or more other antenna feeds is the interference source.

At block 520, an indication of the signal interference event may be transmitted to the interference source. In some embodiments, after identifying the source of a signal interference event as a cellular network base station, the satellite communication system sends an indication of the signal interference event to the interference source. The indication of the signal interference event may include information that can be used to take corrective action by the interference source. For example, the indication may include the frequencies at which the interference was detected and/or the location of the satellite receiver experiencing the interference.

At block 525, an operation of the interference source can be modified. Modifying the operation of the interference source can include causing the interference source to operate on other frequencies. For example, based on the signal interference event, it may be determined that the sub-band within which the interference source was operating overlapped with the frequencies currently in use by the satellite. After making such a determination, the interference source may disable subsequent emissions within that particular sub-band and switch to a different sub-band. Modifying the operation of the interference source can also include causing the interference source to spatially filter transmissions in the direction of the satellite receiver. For example, based on the geographic location where the satellite receiver is located and the location of the interference source, an emission angle from the interference source to the satellite receiver may be determined. After determining the emission angle, the interference source may spatially filter emissions of electromagnetic radiation at the emission angle. Modifying the operation of the interference source may include causing the interference source to alter multiple operating parameters. For example, the operating source may be caused to spatially filter electromagnetic radiation within a particular sub-band at a particular emission angle while still emitting electromagnetic radiation within other sub-bands at the particular emission angle.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method for coordinating shared spectrum usage between fixed communication systems and flexible communication systems, the method comprising:
detecting, by a network interference management system, a signal interference event at a satellite receiver, wherein the satellite receiver is configured to receive data from a satellite utilizing a predefined frequency band;
determining, by the network interference management system, a plurality of characteristics of the satellite receiver, wherein the plurality of characteristics comprise:
a geographic location where the satellite receiver is located; and
an alignment for the satellite receiver, wherein the alignment is indicative of a field of view of the satellite receiver, and the satellite is within the field of view;
identifying, by the network interference management system and based at least in part on the plurality of characteristics, an interference source, wherein the interference source emits electromagnetic radiation within the predefined frequency band; and
transmitting, by the network interference management system, an indication of the signal interference event to the interference source wherein the transmitted indication of the signal interference event causes the interference source to modify an operation of the interference source.

2. The method for coordinating shared spectrum usage between fixed broadcast systems and flexible network systems of claim 1, wherein identifying the interference source comprises identifying, from a plurality of cellular network base stations configured to transmit cellular network data, an interfering base station located within the field of view of the satellite receiver.

3. The method for coordinating shared spectrum usage between fixed broadcast systems and flexible network systems of claim 2, further comprising:
receiving network activity data for the interfering base station, wherein the network activity data is indicative of times and frequencies at which the interfering base station transmitted the cellular network data to devices connected to a cellular network; and
determining that the network activity data coincides with the signal interference event.

4. The method for coordinating shared spectrum usage between fixed broadcast systems and flexible network systems of claim 1, further comprising:
detecting a plurality of signal interference events at a plurality of satellite receivers, wherein:
the plurality of signal interference events comprises the signal interference event; and
the plurality of satellite receivers comprises the satellite receiver; and
determining, for each of the plurality of satellite receivers, the plurality of characteristics; and
wherein identifying the interference source comprises identifying, from a plurality of cellular network base stations, an interfering base station located within the field of view of the satellite receiver and the fields of view of at least two other satellite receivers of the plurality of satellite receivers.

5. The method for coordinating shared spectrum usage between fixed broadcast systems and flexible network systems of claim 1, wherein the satellite receiver comprises a plurality of antenna feeds and identifying the interference source comprises:
determining an amount of signal interference detected by each antenna feed of the plurality of antenna feeds.

6. The method for coordinating shared spectrum usage between fixed broadcast systems and flexible network systems of claim 1, further comprising:
receiving, at an active detector coupled with the satellite receiver, the electromagnetic radiation emitted by the interference source;
generating, by the active detector and based on the electromagnetic radiation received at the active detector, the signal interference event, wherein the signal interference event comprises at least one of an identification of the interference source, a frequency at which the electromagnetic radiation was received; or an angle of arrival of the electromagnetic radiation at the active detector; and
transmitting the signal interference event to a satellite communication system coupled with the satellite.

7. The method for coordinating shared spectrum usage between fixed broadcast systems and flexible network systems of claim 6, wherein the signal interference event is transmitted to the satellite communication system from the satellite receiver via the satellite.

8. The method for coordinating shared spectrum usage between fixed broadcast systems and flexible network systems of claim 6, wherein the signal interference event is transmitted to the satellite communication system from the active detector via the interference source.

9. The method for coordinating shared spectrum usage between fixed broadcast systems and flexible network systems of claim 1, wherein determining the alignment for the satellite receiver comprises:
determining an orbital location of the satellite; and
determining, based on the geographic location where the satellite receiver is located and the orbital location of the satellite, an elevation and an azimuth that positions the satellite within the field of view of the satellite receiver.

10. The method for coordinating shared spectrum usage between fixed broadcast systems and flexible network systems of claim 1, further comprising:
determining, based on the signal interference event, a sub-band of the predefined frequency band at which the electromagnetic radiation emitted by the interference source causes interference at the satellite receiver; and
disabling emissions by the interference source at the sub-band of the predefined frequency band.

11. The method for coordinating shared spectrum usage between fixed broadcast systems and flexible network systems of claim 1, further comprising:
determining, based on the geographic location for the satellite receiver and a location of the interference source, an emission angle from the interference source at which the electromagnetic radiation emitted by the interference source causes interference at the satellite receiver; and
spatially filtering emission of the electromagnetic radiation at the emission angle.

12. The method for coordinating shared spectrum usage between fixed broadcast systems and flexible network systems of claim 1, wherein:
the satellite is controlled by a satellite communication system; and
the satellite communication system comprises the network interference management system.

13. The method for coordinating shared spectrum usage between fixed broadcast systems and flexible network systems of claim 1, wherein the satellite is controlled by a satellite communication system communicatively coupled with the network interference management system and the method further comprises:
transmitting, by the satellite communication system, the signal interference event and the plurality of characteristics of the satellite receiver to the network interference management system.

14. A shared spectrum communication system, comprising:
a satellite configured to transmit data utilizing a predefined frequency band;
a satellite receiver configured to receive the data from the satellite;
a cellular network system comprising a plurality of base stations, wherein each base station of the plurality of base stations is configured to emit electromagnetic radiation within the predefined frequency band; and
a network interference management system configured to:
detect a signal interference event at the satellite receiver;
determine a plurality of characteristics for the satellite receiver, wherein the plurality of characteristics comprise:
a geographic location where the satellite receiver is located; and
an alignment for the satellite receiver, wherein the alignment is indicative of a field of view of the satellite receiver, and the satellite is within the field of view;
identify, based at least in part on the plurality of characteristics, an interfering base station of the plurality of base stations; and
transmit an indication of the signal interference event to the cellular network system wherein the transmitted indication of the signal interference event causes the interfering base station to modify an operation of the interfering base station.

15. The shared spectrum communication system of claim 14, wherein identifying the interfering base station comprises identifying a base station of the plurality of base stations located within the field of view of the satellite receiver.

16. The shared spectrum communication system of claim 14, further comprising a plurality of satellite receivers comprising the satellite receiver, wherein the network interference management system is further configured to:
detect a plurality of signal interference events at the plurality of satellite receivers, the plurality of signal interference events comprising the signal interference event;
determine, for each of the plurality of satellite receivers, the plurality of characteristics; and
identify, from a plurality of cellular network base stations, an interfering base station located within the fields of view of at least two other satellite receivers of the plurality of satellite receivers.

17. The shared spectrum communication system of claim 14, further comprising:
a satellite communication system comprising the satellite, the satellite receiver, and the network interference management system.

18. A network interference management system configured to perform operations including:
detecting a signal interference event at a satellite receiver, wherein the satellite receiver is configured to receive data from a satellite utilizing a predefined frequency band;
determining a plurality of characteristics of the satellite receiver, wherein the plurality of characteristics comprise:
a geographic location where the satellite receiver is located; and
an alignment for the satellite receiver, wherein the alignment is indicative of a field of view of the satellite receiver, and the satellite is within the field of view;
identifying an interference source, wherein the interference source emits electromagnetic radiation within the predefined frequency band; and
transmitting an indication of the signal interference event to the interference source wherein the transmitted indication of the signal interference event causes the interference source to modify an operation of the interference source.

19. The network interference management system of claim 18, wherein identifying the interference source comprises identifying, from a plurality of cellular network base stations configured to transmit cellular network data, an interfering base station located within the field of view of the satellite receiver.

20. The network interference management system of claim 18, wherein:
the satellite is controlled by a satellite communication system; and
the satellite communication system comprises the network interference management system.
